(19) United States
(12) Patent Application Publication
(10) Pub. No.: US 2007/0092082 A1
(43) Pub. Date: Apr. 26, 2007

(54) Digital rights management security mechanism for use in a wireless communication apparatus

(76) Inventor: Frederick A. Rush, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/255,692

(22) Filed: Oct. 21, 2005

(51) Int. Cl. H04L 9/00

(52) U.S. Cl. 380/277

(57) ABSTRACT

A wireless communication apparatus includes a processor core and a security unit. The processor core may receive digital content encrypted with a first encryption key and may store the encrypted digital content within a memory unit of the wireless communication apparatus. The processor core may also receive a second encryption key encrypted with a third encryption key and may store the encrypted second encryption key within the memory unit. The security unit may decrypt the second encryption key using a fourth encryption key that was stored within a programmable memory unit such as a one-time programmable memory, for example. The wireless communication apparatus further includes an encryption/decryption unit that may decrypt the digital content into clear text digital content using the second encryption key. The clear text digital content may be stored with another memory unit such as a random access memory (RAM), for example.

### BACKGROUND OF THE INVENTION

1. Field of the Invention

This invention relates to wireless communication devices and, more particularly, to security within wireless communication devices.

2. Description of the Related Art

The proliferation of wireless communication devices such as mobile phones, for example, has increased dramatically in the recent past. This trend appears to be continuing for the foreseeable future. The advantages of having wireless communication, particularly global wireless communication, are too numerous to list. However, there is a downside to the growing popularity of wireless communication devices and services. A market for illegally obtained or manufactured wireless communication devices and services, and illegally obtained digital content has emerged and is also growing. Such illegal activities may create a significant loss of revenue for manufacturers, operators, and content providers alike.

Accordingly, in response to these types of activities, mobile phone manufacturers may desire to protect the designs and code created to implement a mobile phone or other wireless communication apparatus, game, song, ring tone, and the like. In addition, operators may desire to ensure that the proper customers are using the mobile phones supplied by the operator, and others are not fraudulently using their services. Further, content providers may desire to protect digital content that may be afforded protection under Digital Rights Management. It is noted that Digital Rights Management typically refers to any of several methods used to control or restrict the use of digital content such as digital media content on electronic devices with certain technologies. The digital content may generally include music, visual artwork, computer and video games, and movies, for example.

Some conventional security measures have been implemented in mobile telephones. However, they may impact the way the mobile phone works. More particularly, these conventional security measures, once implemented, may affect the phone's operation by actively scrambling all address and/or data signals to and from memory devices within the phone. Thus, these types of security measures are in the critical path all the time and may adversely affect performance of the mobile phone. Furthermore, due to the nature of these conventional security measures, they may provide limited security flexibility.

### SUMMARY

Various embodiments of a digital rights management security mechanism for use in a wireless communication apparatus are disclosed. In one embodiment, the wireless communication apparatus includes a processor core and a programmable memory unit such as a one-time programmable memory, for example. The wireless communication apparatus also includes a security unit that is coupled to the programmable memory unit. The processor core may receive digital content encrypted with a first encryption key and may store the encrypted digital content within a memory unit of the wireless communication apparatus. The processor core may also receive a second encryption key encrypted with a third encryption key and may store the encrypted second encryption key within the memory unit. The security unit may decrypt the second encryption key using a fourth encryption key that was stored within a programmable memory unit. The wireless communication apparatus further includes an encryption/decryption unit that may decrypt the digital content into clear text digital content using the second encryption key. In one specific implementation, the clear text digital content may be stored with another memory unit such as a random access memory (RAM), for example.

In another embodiment, a method of securing digital content within a wireless communication apparatus may include receiving clear text digital content and storing the clear text digital content within a first memory unit of the wireless communication apparatus. Further the method may include receiving a first encryption key that is encrypted with a second encryption key, and retrieving a third encryption key from a programmable memory unit such as a one-time programmable memory, for example, within the wireless communication apparatus. The method may also include decrypting the encrypted first encryption key using the third encryption key and encrypting the clear text digital content using the decrypted first encryption key and storing the encrypted digital content within a second memory unit of the wireless communication apparatus.

In yet another embodiment, a method of securing digital content within a wireless communication apparatus may include retrieving a first encryption key, which may be in an encrypted state, from a first memory unit such as a flash memory, for example, of the wireless communication apparatus. The method may also include decrypting the first encryption key using a second encryption key that was stored within a programmable memory unit such as a one-time programmable memory, for example, of the wireless communication apparatus. The method may further include retrieving and decrypting encrypted digital content into clear text digital content using the decrypted first encryption key. In one implementation, the method may also include storing and accessing the clear text digital content within a second memory unit such as a random access memory (RAM), for example, of the wireless communication apparatus.

### BRIEF DESCRIPTION OF THE DRAWINGS

FIG. 1 is a block diagram of one embodiment of a system including a wireless communication apparatus.

FIG. 2 is a block diagram illustrating detailed aspects of one embodiment of the digital processing circuit of the communication apparatus shown in FIG. 1.

FIG. 3 is a diagram of one embodiment of the security unit of FIG. 1 and FIG. 2.

FIG. 4 is a flow diagram describing generalized security operation of the communication apparatus of FIG. 1.

FIG. 5 is a flow diagram describing an exemplary flash security programming operation of one embodiment of the communication apparatus of FIG. 1.

FIG. 6 is a flow diagram describing an exemplary authentication device lock security programming operation of one embodiment of the communication apparatus of FIG. 1.

FIG. 7 is a flow diagram describing an exemplary feature security programming operation of one embodiment of the communication apparatus of FIG. 1.

FIG. 8 is a flow diagram describing an exemplary serial number security programming operation of one embodiment of the communication apparatus of FIG. 1.

FIG. 9 is a flow diagram describing an exemplary digital rights management security programming operation of one embodiment of the communication apparatus of FIG. 1.

FIG. 10 is a flow diagram describing an exemplary initialization flash memory check operation of one embodiment of the communication apparatus of FIG. 1.

FIG. 11 is a flow diagram describing an exemplary run-time authentication device check operation of one embodiment of the communication apparatus of FIG. 1.

FIG. 12 is a flow diagram describing an exemplary run-time feature check operation of one embodiment of the communication apparatus of FIG. 1.

FIG. 13 is a flow diagram describing an exemplary run-time unlocking of a locked debug port of one embodiment of the communication apparatus of FIG. 1.

FIG. 14 is a flow diagram describing an exemplary digital rights content purchase operation of one embodiment of the communication apparatus of FIG. 1.

FIG. 15 is a flow diagram describing another exemplary digital rights content purchase operation of one embodiment of the communication apparatus of FIG. 1.

FIG. 16 is a flow diagram describing an additional exemplary digital rights content purchase operation of one embodiment of the communication apparatus of FIG. 1.

FIG. 17 is a flow diagram describing an exemplary digital rights content access operation of one embodiment of the communication apparatus of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

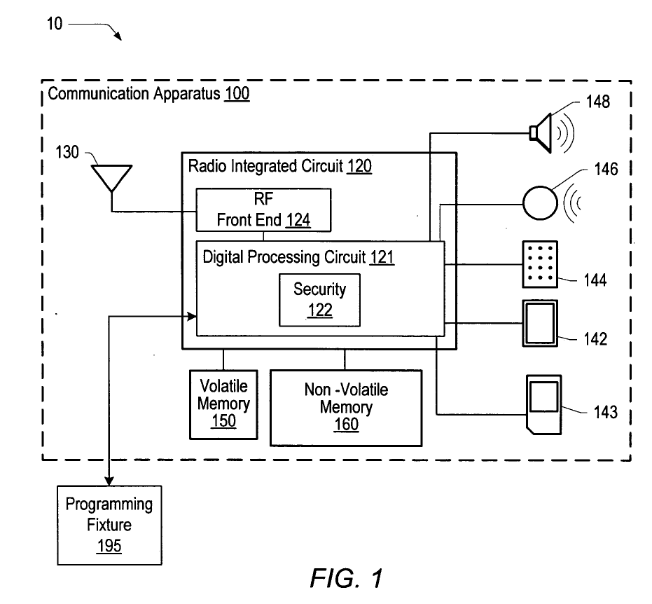

Turning now to FIG. 1, a generalized block diagram of one embodiment of a system including a wireless communication apparatus is shown. System 10 includes a wireless communication apparatus 100 coupled to a programming fixture 195. Communication apparatus includes a radio integrated circuit 120 that is coupled to a volatile memory 150 and a non-volatile memory 160. An antenna 130 is also shown coupled to radio integrated circuit 120. It is noted that in other embodiments, non-volatile memory 160 may include one or more physical non-volatile memory units. It is also noted that in other embodiments, one or both of volatile memory 150 and a non-volatile memory 160 may be included within radio integrated circuit 120.

In the illustrated embodiment, the radio integrated circuit 120 includes an RF front-end circuit 124 that is coupled to a digital processing circuit 121. As shown, various user interfaces including a display 142, an authentication device 143, a keypad 144, a microphone 146, and a speaker 148 are coupled to digital processing circuit 121. However, depending upon the specific application of communication apparatus 100, other types of user interfaces may be used. As such, it is noted that in various embodiments, communication apparatus 100 may include additional components and/or couplings not shown in FIG. 1 and/or exclude one or more of the illustrated components, depending on the desired functionality.

Communication apparatus 100 is illustrative of various wireless devices including, for example, mobile and cellular phone handsets, machine-to-machine (M2M) communication networks (e.g., wireless communications for vending machines), so-called “911 phones” (a mobile handset configured for calling the 911 emergency response service), as well as devices employed in emerging applications such as 3G, satellite communications, and the like. As such, wireless communication apparatus 100 may provide RF reception functionality, RF transmission functionality, or both (i.e., RF transceiver functionality).

Communication apparatus 100 may be configured to implement one or more specific communication protocols or standards, as desired. For example, in various embodiments communication apparatus 100 may employ a time-division multiple access (TDMA) standard or a code division multiple access (CDMA) standard to implement a standard such as the Global System for Mobile Communications (GSM) standard, the Personal Communications Service (PCS) standard, and the Digital Cellular System (DCS) standard. In addition, many data transfer standards that work cooperatively with the GSM technology platform may also be supported. For example, communication apparatus 100 may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ESCD), and the high speed circuit switched data (HSCSD) standard, among others.

RF front-end circuit 124 may include circuitry to provide the RF reception capability and/or RF transmission capability. In one embodiment, RF front-end circuit 124 may down-convert a received RF signal to baseband and/or up-convert a baseband signal for RF transmission. RF front-end circuit 124 may employ any of a variety of architectures and circuit configurations, such as, for example, low-IF receiver circuitry, direct-conversion receiver circuitry, direct up-conversion transmitter circuitry, and/or offset-phase locked loop (OPLL) transmitter circuitry, as desired.

Digital processing circuit 121 may provide a variety of signal processing functions, as desired, including baseband functionality. For example, in one embodiment, digital processing circuit 121 may be configured to perform filtering, decimation, modulation, demodulation, coding, decoding, correlation and/or signal scaling. In addition, digital processing circuit 121 may perform other digital processing functions, such as implementation of the communication protocol stack, control of audio testing, and/or control of user I/O operations and applications. To perform such functionality, digital processing circuit 121 may include various specific circuitry, such as a software programmable microcontroller unit (MCU) and/or digital signal processor (DSP), as well as a variety of specific peripheral circuits such as memory controllers, direct memory access (DMA) controllers, hardware accelerators, voice coder-decoders (CODECs), digital audio interfaces (DAI), UARTs (universal asynchronous receiver transmitters), and user interface circuitry. The choice of digital processing hardware (and firmware/software, if included) depends on the design and performance specifications for a given desired implementation, and may vary from embodiment to embodiment.

In addition, as shown in FIG. 1 digital processing circuit 121 also includes a security unit 122. Security unit 122 may enable a security platform within communication apparatus 100 in an effort to ensure that communication apparatus 100 is authorized to use any of the various services offered by the service and content providers. Further details regarding specific implementations of security unit 122 will be provided below.

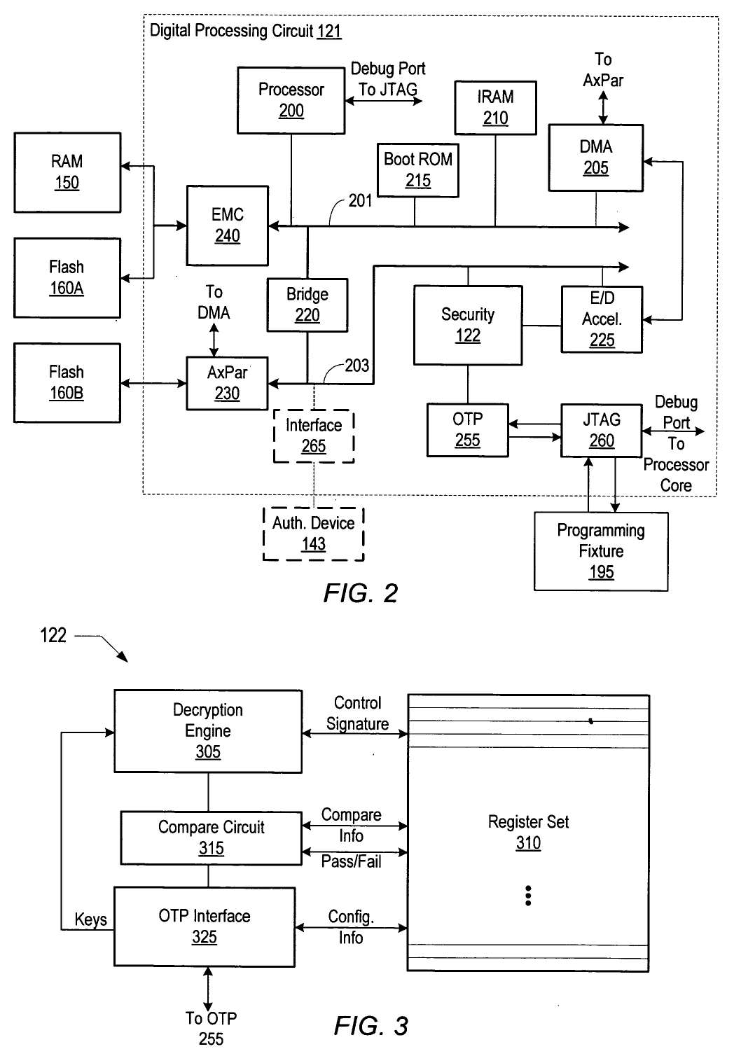

Programming fixture 195 may be representative of any of a variety of programmer units. For example, programming fixture 195 may be a test fixture used to test the functionality and/or connectivity of devices and/or circuit boards within communication apparatus 100. In one embodiment, programming fixture 195 may be coupled to communication apparatus 100 via an interface such as ajoint test action group (JTAG) interface (shown in FIG. 2) that may conform to the IEEE 1149.1 standard. Although in other embodiments programming fixture 195 may be coupled to communication apparatus 100 via other types of interfaces. As will be described further below, programming fixture 195 may be employed to download information such as software and encryption keys, for example, to communication apparatus 100.

In the illustrated embodiment, radio integrated circuit 120 is shown as a single integrated circuit. However, it is noted that in other embodiments, the functional blocks that are shown within radio integrated circuit 120 may be stand-alone devices. More particularly, in other embodiments, communication apparatus 100 may include various discreet components and integrated circuits that provide functionality similar to the functionality provided by radio integrated circuit 120.

Referring to FIG. 2, a block diagram illustrating more detailed aspects of one embodiment of digital processing circuit 121 is shown. Digital processing circuit 121 includes a processor core 200 coupled to a processor bus 201. An internal random access memory (IRAM) 210, a boot read only memory (Boot ROM) 215, a direct memory access (DMA) engine 205, and an external memory controller (EMC) 240 are coupled to processor core 200 via the processor bus 201. An external RAM (RAM) 150 and a flash memory 160A are coupled to the processor bus 201 via EMC 240. In addition, digital processing circuit 121 includes a bus bridge 220 which is coupled between the processor bus 201 and a peripheral bus 203. The peripheral bus 203 is coupled to a flash memory unit 160B via an AxPar controller 230. An encryption/decryption (E/D) accelerator 225 is coupled to DMA engine 205 and to peripheral bus 203. Security unit 122 of digital processing circuit 121 is coupled to peripheral bus 203, E/D accelerator 225 and to a one-time programmable (OTP) memory 255. OTP 255 is coupled to a JTAG interface 260. However, in other embodiments, OTP 255 may be coupled to other communications interfaces. Further, an authentication device 143 is coupled to the peripheral bus 203 via an interface unit 265. It is noted that authentication device 143 and interface unit 265 may be optional in some embodiments (as denoted by the dashed lines). It is also noted that the digital processing circuit 121 components shown in FIG. 2 may be part of the digital processing circuit 121 that is commonly referred to as an programmable MCU subsystem. It is also noted that digital processing circuit 121 may include other subsystems such as a DSP subsystem, for example, that is not shown for simplicity.

Processor core 200 may be representative of a variety of processor cores and may employ a variety of processing architectures. For example, in one embodiment, processor core 200 may be an advanced reduced instruction set computing (RISC) machine (ARM) processor core. As such, processor core 200 may be configured to execute instructions that perform a wide variety of functions for controlling the operation of communication apparatus 100. During operation, processor core 200 may use RAM 210 as a local storage. As described further below, in one implementation, during an initialization such as power up or reset sequence, processor core 200 may execute program instructions that are stored within Boot ROM 215. The initialization instructions may invoke security unit 122 to perform various operations or retrieve information from security unit 122. In one embodiment, processor core 200 may execute a protected mode operating system in which user code may not access hardware without using system calls. It is noted that various alternative embodiments of digital processing circuit 121 may be provided, depending upon the desired functionality.

DMA engine 205 may be configured to control memory transactions and the transfer of data between memory such as RAM 150 and flash 160A without intervention by processor core 200. However, as shown, in some cases digital content may be encrypted when stored within a non-volatile memory. Accordingly, E/D accelerator 225 may be configured to encrypt and decrypt information stored to/from flash 160A or 160B. In one implementation, the E/D accelerator 225 may be a hardware implementation of a stream cipher such as the A5 algorithm used for GSM compatible systems, for example. As described further below, an encryption key used by E/D accelerator 225 may be provided by security unit 122. However, in other embodiments, other encryption algorithms such as a block cipher, for example, may be used.

OTP 255 is a programmable memory and may be representative of any of a variety of programmable memory devices. For example, OTP 255 may be a device in the programmable ROM family such as an electrically programmable ROM (EPROM), or the electrically blown fuse (efuse) family, and the like. In one embodiment, OTP 255 is a one-time programmable memory device. As such, once OTP 255 has been programmed, the contents may not be changed. In the illustrated embodiment, OTP 255 may be programmed via the JTAG interface 260. As will be described further below, in one embodiment, OTP 255 may be programmed during an initial programming of communication apparatus 100 using programming fixture 195, for example. In addition, OTP 255 may include one or more “lock” bits that once programmed, may prohibit any further access to OTP 255 via the JTAG interface 260. Additionally, once the one or more lock bits are programmed, access to a debug port of processor core 200 via the JTAG interface 260 may also be disabled. However, as described further below, access to the processor core debug port via the JTAG interface 260 may be re-enabled using an appropriate signature.

In the illustrated embodiment, EMC 240 may control accesses to RAM 150 and flash 160A, while AxPar 230 may control accesses to flash 160B. In one implementation, flash 160B may be a different type of flash than flash 160A. For example, flash 160A may be implemented using NOR flash technology and flash 160B may be implemented using NAND flash technology. It is noted that when referring to the flash memory, the reference number 160 may be used in place of 160A and 16B where appropriate.

In embodiments that include the interface 265 and authentication device 143, various types of data may be communicated between processor core 200 and authentication device 143, depending on the type of authentication device 143 and the desired functionality of communication apparatus 100. For example, in one embodiment, authentication device 143 may be a smart card implementing an interface that complies with the IS07816-3 standard. More specifically, authentication device 143 may be a subscriber identity module (SIM) further conforming to GSM standards. A SIM may store data such as phone numbers, subscriber identification data, and network authorization data. Information stored in a SIM may be retrieved and used by processor core 200 to perform a variety of tasks. Other features common to authentication device 143 generally and SIMs specifically may include transmission of general information such as manufacturer information, age information, and component identifiers to processor core 200. Depending on the specific type of authentication device, program instructions available to processor core 200, and the desired functionality, a variety of data characters or sequences of data characters may be exchanged between digital processing circuit 121 and authentication device 143 to perform any number of alternative configuration, housekeeping, authentication, authorization, storage, and retrieval tasks.

In one embodiment, security unit 122 is a peripheral device that may perform functions related to the protection of communication apparatus 100 from hacking, operator loss through fraud, and may further aid in the implementation of Digital Rights Management. Security unit 122 does not determine what forms of security are used within communication apparatus 100. However, security unit 122 may provide multiple security options from which manufacturers may select to implement various levels of security. For example, security unit 122 may provide or support features such as a unique device serial number, a flash image check, a SIM Lock check, a feature access check, a Digital Rights Management check, and processor core debug lockout.

More particularly, security unit 122 may supply several functions that may be combined with software to form a security platform for mobile communication systems. The basis of the security platform includes the ability to process public key cryptography in hardware, thereby eliminating the ability to snoop keys using the processor core debug functions. Furthermore, the ability to compare signatures that describe the operation of various components of communication apparatus 100 allows for a robust security implementation, if so desired. For simplicity, it may be possible to selectively remove all security checking, and utilize communication apparatus 100 as if there was no security.

Accordingly, the system security platform enabled by security unit 122 may be thought of as a security toolkit, in the fact that all, some, or none of the features that are described in this peripheral may be used. Software has the option of protecting as much, or as little as desired, and based on the programming of OTP 255 and boot ROM 215, the flash checking may be a configurable method that may be applied at boot time.

As shown, security unit 122 also interfaces with the E/D accelerator 225 to provide a method of encrypting and decrypting content in an efficient manner. In one specific implementation, the GPRS Encryption Algorithm (GEA) initialization state (e.g., a content key) may be extractable from a Digital Rights Management (DRM) signature, and the value may be loaded into the E/D accelerator 225. Following this initialization, digital content may be passed through the E/D accelerator 225 for encryption or decryption as desired.

Furthermore, to secure code running on processor core 200 from being altered during execution, the debug port on processor core 200 that may be accessible via the JTAG interface 260 may be disabled through security unit 122. To re-enable access to the processor core debug port via the JTAG interface 260, the processor core 200 may load a signature comprised of a unique serial number and then request the JTAG access to the processor core debug port be re-enabled.

As described briefly above, security unit 122 may employ public key cryptography. In one embodiment, security unit 122 may use an asymmetrical cryptography algorithm such as, for example, an RSA algorithm. As such, the use of the terms private and public keys, encryption and decryption are used for discussion purposes. More detailed descriptions of the RSA algorithm may be found in various publicly available texts and are thus not provided here for simplicity. However, it is noted that in other embodiments, other algorithms are possible and contemplated.

However, in brief, the selection of which key (i.e., public/private) to use for which operation (i.e., encryption/decryption) is actually a matter of preference, as the operations may be performed in either order, with the same results. When referring to the encryption operation, if the public key is used, and for the decryption operation the private key is used, the following two equations hold:
MessageText=(MessageText^{PublicKey}mod KeyModulo)^{PrivateKey}mod KeyModulo (1)
MessageText=(MessageText^{PrivateKey}mod KeyModulo)^{PublicKey}mod KeyModulo (2)

As equations (1) and (2) demonstrate, either key may be used first, so long as the other key is used second, and the original message may be recovered. The equations also hold if any desired text or message is substituted for MessageText in both locations.

Since the encryption and decryption operations are identical mathematically, the key selection may be the only difference between the two operations. This makes the use of encrypt and decrypt somewhat arbitrary, as it is possible to encrypt with the private key and decrypt with the public key. Similarly, it is possible to decrypt a message using the private key, to later recover the message using the encryption with the public key.

Another important characteristic that makes asymmetrical cryptography useful is the property that the same key cannot be used for encryption and decryption of the same message. This property is illustrated in equations (3) and (4).
MessageText!=(Message^{TextPublicKey}mod KeyModulo)^{PublicKey}mod KeyModulo (3)
MessageText!=(MessageText^{PrivateKey}mod KeyModulo)^{PrivateKey}mod KeyModulo (4)

The property demonstrated by equations 3 and 4 may be especially important for maintaining the validity of signatures. As long as the signing key is not compromised, having widely distributed the other key does not reduce the security of a signature.

In addition, there is the concept of a digital signature to consider when using asymmetrical cryptography. A digital signature allows a guarantee that the message is authentic, because the owner has signed with their key, and no other key could have produced that signature. In general use, the private key is known only by the owner of the key pair. As such, anything that is encrypted using the private key can be attributable to the owner of the key pair, and the public key can be used to verify or check the signature by encrypting the signature to recover the distinguishing marks that validate the message was indeed sent by the key owner. More particularly, a signature that uses the private key to decrypt the intended message, results in a coded message. Conversely, an encryption by the public key results in the original message.

Accordingly, to provide security as described above for communication apparatus 100, there may be two main modes of operation: a factory programming mode and a run-time use mode. During the factory programming mode of operation, the methods and keys for the field operations may programmed into communication apparatus 100 using, for example, programming fixture 195 of FIG. 2. As mentioned above, this may be a one-time operation since OTP 255 is programmed during this operation. Factory programming operations may typically be performed at a manufacturing facility, either at the time of initial manufacturing, or later in the refurbishing of used mobiles, for example. The operations generally detailed in this section involve the use of OTP 255. However, since the various security protections programmed into communications apparatus 100 may be implemented independently, each is described further below in conjunction with the descriptions of FIG. 3 through FIG. 9. It is noted that communications apparatus 100 may be refurbished to include more or less functionality by downloading a new flash image into flash 160.

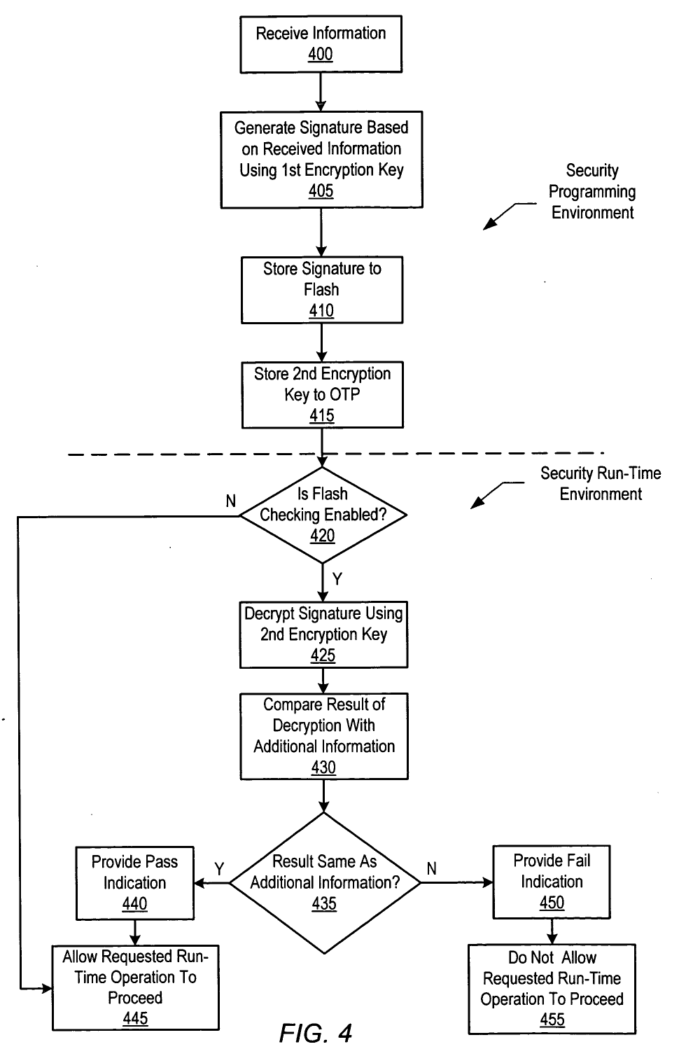

The run-time use model may vary based on the selected security methods. For example, there may be cases where the use of communication apparatus 100 is indicated as restricted or disabled at run time. In these cases, the system software (e.g., operating system and/or boot code) may select the level of functionality that remains in communication apparatus 100, from essentially a “dead” mobile, to a limited “emergency only” mobile, to perhaps no change at all, but operator notification occurs. Accordingly, as each method may be used independently, the various run-time operations are described further below in conjunction with the descriptions of FIG. 3, FIG. 4 and FIG. 10-FIG. 17.

FIG. 3 is a block diagram of one embodiment of the security unit 122 of FIG. 1 and FIG. 2. Security unit 122 includes a decryption engine 305 such as an RSA engine, for example. Decryption engine 305 is coupled to a register set 310 and to a compare circuit 315, which is in turn coupled to an OTP interface 325.

In one embodiment, security unit 122 may be a memory-mapped device within the address space of processor core 200. More particularly, each of the registers in register set 310 may be addressable at a base address plus an offset, for example. However, in other embodiments other register mappings are possible. The registers in register set 310 may provide access to values stored within the OTP 255 that may be used during validation sequences, for example.

As described above, in one embodiment, decryption engine 305 may be implemented using an asymmetric encryption algorithm such as the RSA algorithm, for example. As such, when presented with a signature, security unit 122 may decrypt the signature into a clear text message or some other non-encrypted format by retrieving the appropriate key from OTP 255 using OTP interface 325. It is noted that although in one embodiment the RSA algorithm is used, in other embodiments, other encryption/decryption algorithms may be used.

In one embodiment, compare circuit 315 may be configured to compare the result of the decryption with information provided by processor core 200. As will be described further below, compare circuit 315 may provide a pass/fail indication to processor core 200 depending on the outcome of the comparison.

FIG. 4 is a flow diagram that illustrates generally the programming operation and the run-time operation of one embodiment of communication apparatus 100. Referring collectively to FIG. 2 through FIG. 4, as described above, during factory security programming, the various methods and keys for the field operations may programmed into communication apparatus 100. Accordingly, in one embodiment, information such as operational (e.g., OS) and control information (e.g., features, applications, stack protocol, etc.) may be received (block 400). A signature may be generated by encrypting at least part of the received information with a first encryption key (e.g., public key) (block 405). More particularly, in one embodiment, prior to generating the signature, a digest or hash of the received information may be created using, for example, a one-way hash function such as an MDS algorithm. In such an embodiment, the signature may be generated based on the hash. However, in an alternative embodiment, the signature may be generated based on the entire received information. In either case, the signature may then be stored to flash memory 160 (block 410). Lastly, a second encryption key (e.g., private key) may be downloaded and stored to OTP 255 (block 415).

The received information may include operational (e.g., OS) and control information (e.g., features, applications, stack protocol, etc.) to be stored as a flash image in the flash memory 160 to communication apparatus 100. It is noted that other information such as available features and serial numbers may be downloaded as well.

In one embodiment, programming fixture 195 may receive the information and the keys and perform the signature generation and the hash function. In such an embodiment, programming fixture 195 may download the received information, the signature, and the second encryption key to communication apparatus 100 using the JTAG interface 260 or other interface such as a serial interface (not shown), for example.

In an alternative embodiment, programming fixture 195 may download the received information such as operational (e.g., OS) and control information (e.g., features, applications, stack protocol, etc.) to be stored as a flash image in the flash memory 160. In addition, programming fixture 195 may download the first encryption key (e.g., public key) to communication apparatus 100.

Once the information is downloaded to communication apparatus 100, processor core 200 may generate the signature by encrypting the information with the first key. Alternatively, programming fixture 195 may generate a digest or a hash of all or part of the information using, for example, an MD5 algorithm prior to generating a signature. Programming fixture may then download the hash to communication apparatus 100. In such an alternative embodiment, processor core 200 may generate the signature based on the hash instead of the entire flash image. Processor core 200 may write the signature to flash memory 160.

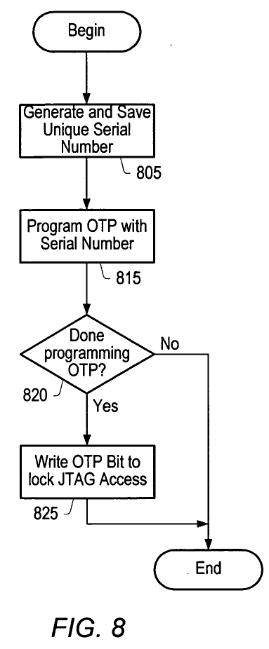

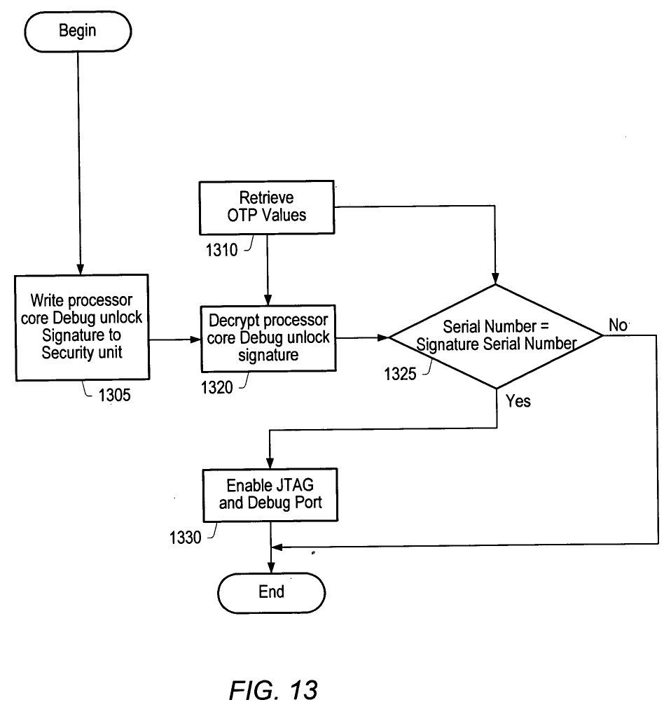

The programming sequence may be repeated until any information that needs to be stored in the OTP 255 has been stored. As will be described in greater detail below, once the OTP has been programmed, one or more predetermined lock bits may be programmed within OTP 255. As such, in one embodiment, security unit 122 may prevent further access to OTP 255 and to the debug port of processor core 200 via JTAG interface 260. More particularly, without this feature, during normal operations processor core 200 may be accessible via JTAG interface 260 in a debug mode. This type of debug access could breach any security features. Accordingly, in one embodiment, the processor core debug port access may be disabled once the one or more lock bits within OTP 255 have been programmed. As will be described further below in conjunction with the descriptions of FIG. 8 and FIG. 13, the processor core debug port access via JTAG interface 260 may be re-enabled by security unit 122 using a unique serial number.

Further, in some embodiments, boot code may be programmed into the boot ROM 215 during manufacturing. As will be described further below, the boot code may determine which features and functions, if any, will be checked and/or enabled at run time.

During the run-time environment, in one embodiment, depending on the functionality that has been programmed into the boot code or the operating system, flash checking may be required (block 420). For example, during boot up, the processor core 200 may execute boot code that requests a check of the integrity of the flash contents to ensure that only authorized features and operations are loaded. If no flash checking is required, operation proceeds to block 445, where processor core 200 may continue with any requested run-time operation.

However, if flash integrity checking is required (block 420), processor core 200 may request the check by writing to a control register within register set 310 and writing the flash signature to security unit 122. Processor core 200 may also write additional information such as the flash image, or alternatively a hash of the image to security unit 122. In response to the request, decryption engine 305 may retrieve the second encryption key from OTP Interface 325 and decrypt the signature using the second key (block 425).

Compare circuit 315 may compare the result of the decryption (e.g., digest, hash, or flash image) with the additional information (e.g., current digest, hash, or flash image) (block 430). If compare circuit 315 determines the result and the additional information are the same (block 435), compare circuit 315 may provide a pass indication to processor core 200 (block 440). Operation proceeds as described above in the description of block 445, where processor core 200 may be allowed to continue booting, or to continue with an application start-up for example.

Referring back to block 435, if the compare circuit 315 determines the result and the additional information are the not same, compare circuit 315 may provide a fail indication to processor core 200 (block 450). In response to the fail indication, processor core 200 may not allow the requested run-time operation to continue (block 455). Depending on the requested run-time operation, the failure response may take various forms in various embodiments. For example, in one embodiment, processor core 200 may halt further execution, thus locking up communication apparatus 100. In another embodiment, processor core 200 may continue the requested operation, but may notify the network operator of the failure condition.

The above flow may allow the features and operation to be modified during refurbishment or during field upgrades. In such cases, the flash image may be downloaded in the field as long as the first encryption key of the two-key pair is used to generate a corresponding signature.

However, there may be some low-cost wireless communication devices that are considered to be disposable and refurbishment may not be cost effective. In such cases an alternative embodiment of wireless communication apparatus is contemplated. In the alternative embodiment, during programming, the flash image may be downloaded and a hash of the image may be generated using, for example, the MD5 algorithm as described above. However, instead of generating a signature using an encryption key, the entire hash may be stored within OTP 255. Accordingly, during run-time operation, if flash checking is required, a new hash may be generated based upon the current flash image stored in flash memory 160. This new hash may be provided to compare circuit 315. In addition, compare circuit 315 may retrieve the hash stored within OTP 255 to determine if they are the same. Operation thereafter may be the same as that shown in FIG. 4. Thus, although not as robust as a system that uses signature verification, there may be less overhead by not having to generate and maintain storage of encryption keys and corresponding databases, etc.

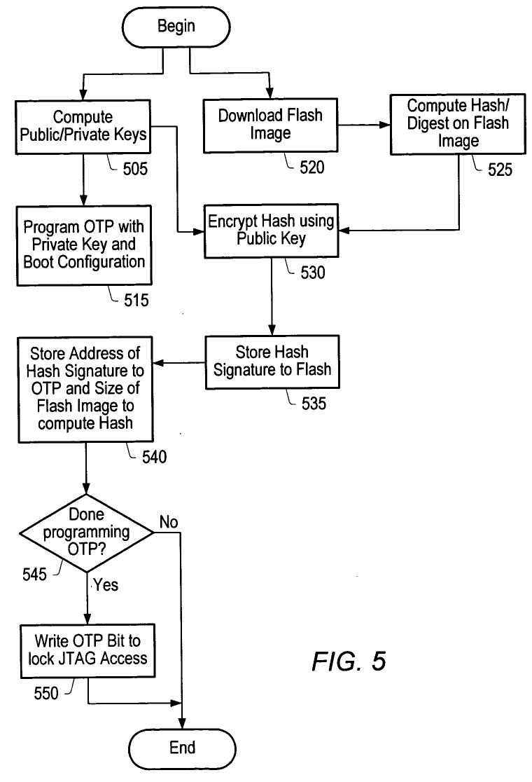

FIG. 5 through FIG. 9 are flow diagrams that illustrate various specific operations of an embodiment of communication apparatus 100 in the programming mode of operation. FIG. 5 is a flow diagram describing an exemplary flash security programming operation of one embodiment of communication apparatus 100.

Referring collectively to FIG. 2, FIG. 3 and FIG. 5, during security programming, the public and private keys of an asymmetrical encryption key pair may be generated by programming fixture 195 or generated by an external source and supplied to programming fixture 195 (block 505) and subsequently saved to a handset database, for example, that may be used to store keys. The programming fixture 195 may then store the private key and any boot configuration information to OTP 255 via JTAG interface 260 (block 515).

In addition, the programming fixture 195 may download information such as operational (e.g., OS) and control information (e.g., features, applications, stack protocol, etc.) to communication apparatus 100 to be stored as a flash image in the flash memory 160 (block 520).

In one embodiment, the programming fixture 195 may compute a hash of the flash image using an MD5 algorithm, for example (block 525). It is contemplated that other hashing algorithms may be used in other embodiments. Programming fixture 195 may generate a signature by encrypting the hash using the public key (block 530). In addition, programming fixture 195 may store the signature to flash memory unit 160 (block 535).

In an alternative embodiment, the programming fixture 195 may also download the public key to processor core 200. Processor core 200 may compute a hash of the flash image (block 525), and then generate a signature by encrypting the hash using the public key (block 530).

Processor core 200 may store the signature to flash memory unit 160 (block 535). In addition, programming fixture 195 may write the address at which the signature is stored in the flash into OTP 255. Further, programming fixture 195 may write the size of the flash image to OTP 255 (block 540). As will be described further below, the address of the signature and the size of the flash image may be used when retrieving the signature and computing the hash, respectively, during run-time operations. In one embodiment, writing to OTP 255 may include programming fixture 195 using the JTAG interface 260 to access OTP 255.

If the programming operations are not complete, further programming may be performed at this time. However, if programming operations have been completed, programming fixture 195 may write the one or more predetermined lock bits within OTP 255 to lock JTAG interface 260 (block 550). As described above, locking JTAG interface 260 includes permanently disabling any further accesses to OTP 255 by JTAG interface 260 and also to disable access to the debug port of processor core 200 via JTAG interface 260, for example. However, the debug port access may be re-enabled, as described further below.

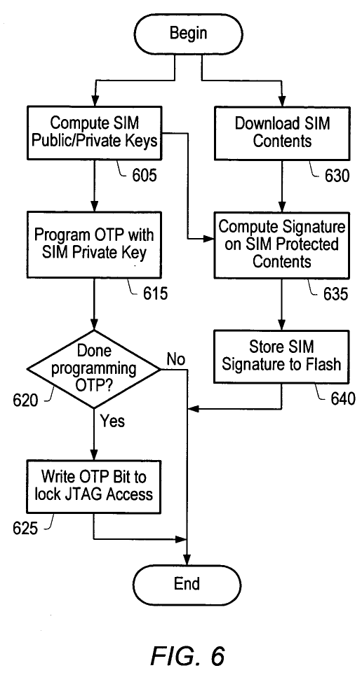

FIG. 6 is a flow diagram describing an exemplary SIM lock security programming operation of one embodiment of communication apparatus 100. There may be multiple methods that can be used to lock a SIM. However, in one embodiment the SIM lock security check feature may be implemented as a hardware assisted method to software. More particularly, the method used for the SIM lock may be implemented in software, possibly locking to an operator, network, or other lock type, with security unit 122 validating whether the lock value is accepted based on signatures placed into flash memory 160.

Referring collectively to FIG. 2, FIG. 3 and FIG. 6, during security programming, the SIM public and SIM private keys of an asymmetrical encryption key pair may be generated or computed (block 605). For example, programming fixture 195 may generate the keys or alternatively an external key generation device (not shown) may generate the keys. In either case, the keys may be subsequently saved to a key database, for example. If the external device generates the keys, the keys may be downloaded to programming fixture 195 via any of a variety of methods. The programming fixture 195 may then store the SIM private key to OTP 255 via JTAG interface 260 (block 615).

In addition, the programming fixture 195 may download one or more portions of the SIM contents from the SIM (block 630). The SIM contents may be downloaded using any type of mechanism. For example, the SIM contents may be read by programming fixture 195 using a credit card-type reader, although other mechanisms are possible. Programming fixture 195 may generate a signature by encrypting the one or more portions of the SIM contents using the public key (block 635). For example, one or more subsets of the SIM contents such as network selection, calling regions, and the like may be encrypted. Programming fixture 195 may store the signature to flash memory unit 160 (block 640).

If the programming operations are not complete, further programming may be performed at this time (block 620). However, if programming operations have been completed, programming fixture 195 may write one or more predetermined lock bits within OTP 255 to lock JTAG interface 260 (block 625).

It is noted that in an alternative embodiment, programming fixture 195 may download the public key and the one or more portions of the SIM contents to processor core 200. Processor core 200 may then generate the signature and store the signature to flash memory 160.

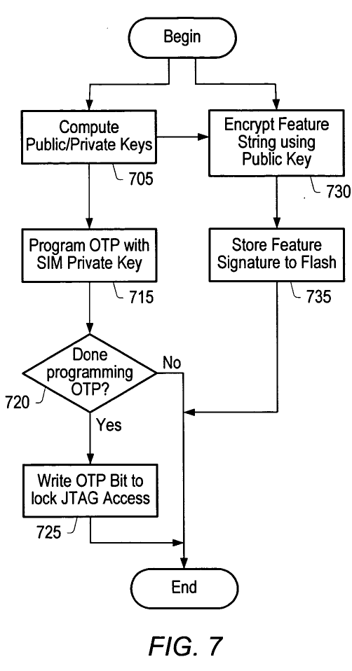

As mentioned above, to allow a manufacturer to produce a single flash image with multiple platforms possible, a method to distinguish the models, and ensure that only the features purchased are accessible is desirable. This may be implemented using a feature string security signature. Accordingly, FIG. 7 is a flow diagram describing an exemplary feature string security programming operation of one embodiment of communication apparatus 100. More particularly, using one or more bits per feature, the manufacturer or operator can determine which features of a mobile may be enabled by setting the appropriate bits in the feature string. This feature string is then signed, and stored into flash memory 160. To allow for updates to the features, a new signature, with the additional features may be downloaded into the mobile, thereby enabling additional features.

Referring collectively to FIG. 2, FIG. 3 and FIG. 7, the feature string security programming is similar to the programming described in FIG. 6. For example, the feature set public and private keys of an asymmetrical encryption key pair may be generated or computed (block 705). For example, programming fixture 195 may generate the keys, or alternatively an external key generation device (not shown) may generate the keys. In either case, the keys may be subsequently saved to a key database, for example. If the external device generates the keys, the keys may be downloaded to programming fixture 195 via any of a variety of methods. The programming fixture 195 may then store the feature private key to OTP 255 via JTAG interface 260 (block 715).

In addition, the programming fixture 195 may generate a signature by encrypting the feature string using the public key (block 730). Programming fixture 195 may store the signature to flash memory unit 160 (block 735).

If the programming operations are not complete, further programming may be performed at this time (block 720). However, if programming operations have been completed, the programming fixture 195 may write the one or more predetermined bits within OTP 255 to lock JTAG interface 260 (block 725) as described above.

In an alternative embodiment, programming fixture 195 may download the feature string and the public key to processor core 200. Processor core 200 may generate the signature by encrypting the feature string using the public key. Processor core 200 may store the signature to flash memory unit 160.

To support software based security systems, the ability to uniquely identify a given communication apparatus may be required. For this, as well as additional purposes that are described further below, a unique identification number such as a serial number, for example, may be loaded into communication apparatus 100. It is noted that the identification number may be programmed at a number of locations. For example, programming may be performed during package testing through final assembly.

As such, FIG. 8 is a flow diagram illustrating the serial number programming operation of one embodiment of communication apparatus 100. Referring collectively to FIG. 2, FIG. 3 and FIG. 8, programming fixture 195 may generate a unique serial number (block 805) and store the serial number to a handset database, for example. The programming fixture 195 may also store the serial number within OTP 255 via JTAG interface 260 (block 815). It is noted that programming fixture may also request and receive (e.g. retrieve) the unique serial number from a serial number master list, in which the serial numbers may be allocated by manufacturer, for example.

If the programming operations are not complete, further programming may be performed at this time (block 820). However, if programming operations have been completed, the programming fixture 195 may write to one or more predetermined bits within OTP 255 to lock JTAG interface 260 (block 825).

As described above, the ability to provide a greater protection of digital content on mobile platforms has become a necessity. For example, due to copyright, it may be necessary to protect the works of others supplied on a network for use in a mobile device, and ensure that the rights owners are adequately protected to receive compensation for their works. There are many possibilities that can be implemented using the security toolkit provided in communication apparatus 100. However, the final determination of what security features will be implemented may be left to the manufacturers and operators.

To secure rights works on a communication apparatus 100, the content can be encrypted. In various implementations, the location that the encryption occurs can vary. In some instances, the rights owner may wish to only distribute the work in an encrypted form. In other cases, the work may be obtained in a readable form, but may require that the work is stored in an encrypted form on communication apparatus 100. Both options may be supported within communication apparatus 100. As described in greater detail below, E/D accelerator 225 may encrypt or decrypt content and security unit 122 may supply an encryption key to E/D accelerator 225.

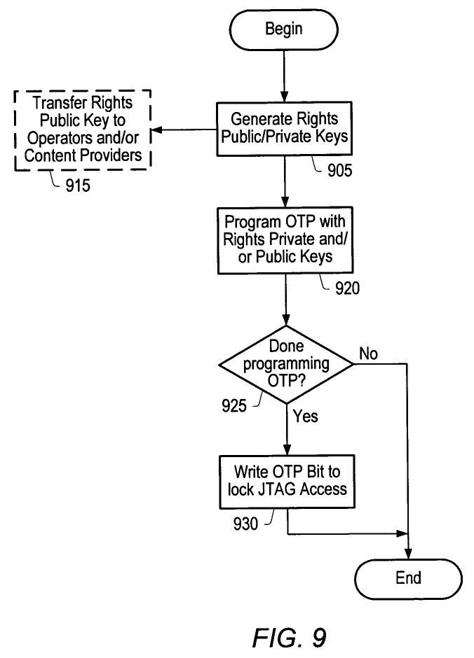

Since the signatures of the Digital Rights Management may contain the actual key(s) for the E/D accelerator 225, the security unit 122 may provide the capability to decrypt the signatures to recover the key(s). In some cases, the location of the public key may reside within communication apparatus 100, and be made available to content providers to ship the decryption keys to communication apparatus 100. The programming operation described in conjunction with FIG. 9 indicates the public key is also included in the OTP 255. However, it is noted that in other embodiments this may not be the case.

FIG. 9 is a flow diagram describing an exemplary digital rights management security programming operation of one embodiment of communication apparatus 100. Referring collectively to FIG. 2, FIG. 3, and FIG. 9 the digital rights public and private keys of an asymmetrical encryption key pair may be generated by programming fixture 195 (block 905) and subsequently saved to a handset key database, for example, which may be used to store keys. Alternatively, the digital rights public and private keys of an asymmetrical encryption key pair may be generated by an external key generation device and made available to programming device 195.

As indicated by the dashed line, in one embodiment, the digital rights public key may be transferred to the network operators or the content providers as desired, depending on the specific implementation of the content distribution and purchasing arrangements (block 915). However, as described above, the digital rights public key may be stored within communication apparatus. As such, the programming fixture 195 may store the rights private and/or public keys to OTP 255 via JTAG interface 260 (block 920).

If the programming operations are not complete, further programming may be performed at this time (block 925). However, if programming operations have been completed, the programming fixture 195 may write to one or more predetermined bits within OTP 255 to lock JTAG interface 260 (block 930).

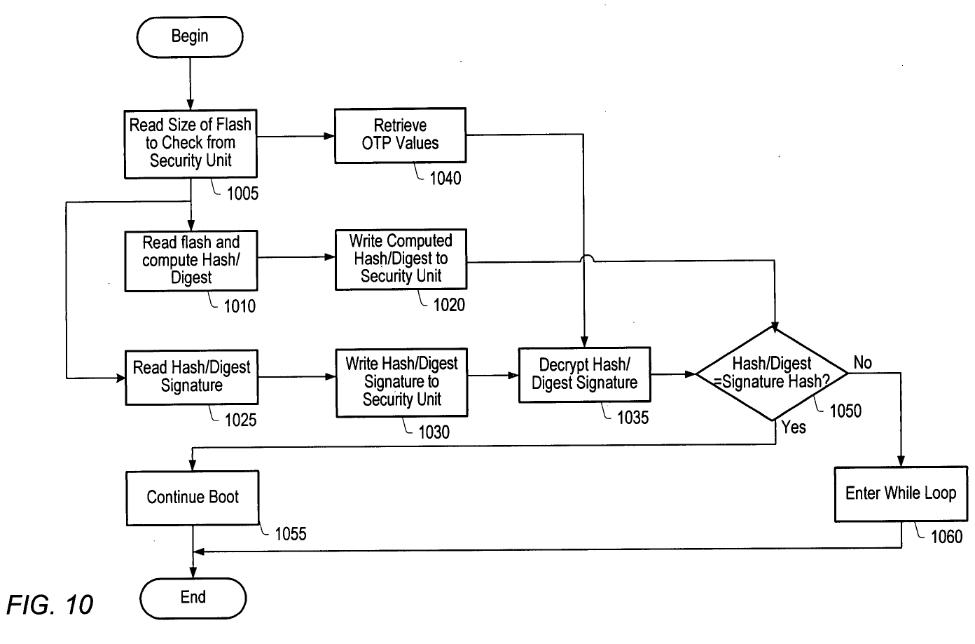

FIG. 10 through FIG. 17 are flow diagrams that illustrate various specific run-time operations of an embodiment of communication apparatus 100. As described above, once OTP 255 has been programmed and communication apparatus 100 is ready for use, further operation may proceed in the run-time mode. Further, it is noted that an operating system that has been verified through flash checking and is executed by processor core 200 may be aware of the security features that have been loaded.

Turning to FIG. 10 a flow diagram describing an exemplary initialization flash memory check operation of one embodiment of the communication apparatus 100 of FIG. 1 is shown. Referring collectively to FIG. 1 through FIG. 3 and FIG. 10, during initialization such as may be performed at power up or after a reset, for example, processor core 200 may execute boot code from boot ROM 215. In addition, security unit 122 may retrieve a flash private key that was previously stored within OTP 255. Security unit 122 may also load various internal registers (block 1040) within register set 310 with values stored within OTP 255. Processor core 200 may determine the size of the flash to check by reading one or more registers within register set 310 (block 1005). It is noted that the flash size to be checked is implementation specific and may be a portion of the flash image or the entire flash image that was stored during programming operations. Processor core 200 may then read the flash memory 160 and calculate a hash using the MD5 algorithm, for example (block 1010). Processor core 200 may write the computed hash to security unit 122 (block 1020). In addition, processor core 200 may read the hash signature from the flash (block 1025), and then write the hash signature to security unit 122 (block 1030).

Security unit 122 decrypts the signature using the private key (block 1035) resulting in a hash of the flash image stored during programming operations. Security unit 122 compares the decryption result with the hash that was read from flash memory 160 (block 1050).

If the hash resulting from the decryption is not the same as the hash that was read from flash memory, security unit 122 may provide a fail indication to processor core 200. As such, processor core 200 may enter a non-exiting while loop (block 1060). In one embodiment, the while loop may include instructions that may cause communication apparatus 100 to notify the network operator of the failure. However, in other embodiments, the while loop may include instructions that may cause communication apparatus 100 to become non-functional or partially functional, as desired.

Referring back to block 1050, if the hash resulting from the decryption is the same as the hash that was read from flash memory, security unit 122 may provide a pass indication to processor core 200. Accordingly, processor core 200 may continue executing boot code and the boot process may continue (block 1055).

Once the flash memory contents and thus the operating system has been verified, the platform and the software loaded into flash memory 160 may be considered to be safe and other security checks may be performed during run-time operations. For example, authentication devices such as a SIM card may be verified to ensure that communication apparatus 100 is only being used on appropriate networks, as defined by a SIM lock which may be defined by the manufacturer and/or the operator and implemented as a lock value in software. Additionally, application software loaded on communication apparatus 100 may itself check to determine whether it is authorized to run. Accordingly, the operating system or other run-time application code may verify the SIM and the feature set through security unit 122.

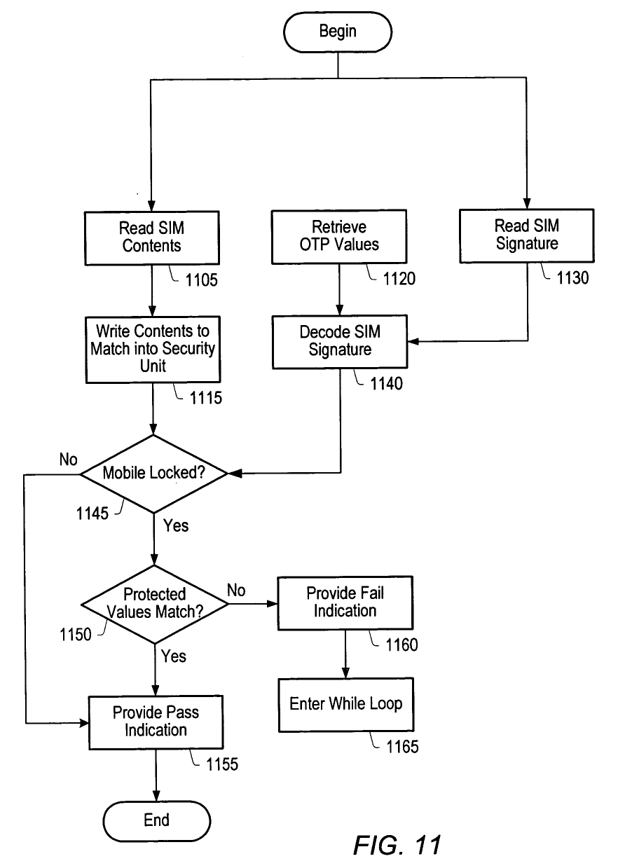

FIG. 11 is a flow diagram describing an exemplary run-time authentication device check operation of one embodiment of the communication apparatus 100. Referring collectively to FIG. 1 through FIG. 3 and FIG. 11, during initialization such as may be performed at power up or after a reset, for example, processor core 200 may execute boot code from boot ROM 215. Security unit 122 may retrieve a SIM private key that was previously stored within OTP 255 during programming operations. Security unit 122 may also initialize/load various internal registers within register set 310 with values stored within OTP 255 (block 1120). In addition, processor core 200 may read at least portions of the SIM contents (e.g., protected contents) (block 1105) from the SIM. Processor core 200 may write the portions of SIM contents to one or more registers within register set 310 of security unit 122 (block 1115). Further, processor core 200 may read the SIM signature that was previously stored within flash memory 160 (block 1130).

Security unit 122 may decrypt the SIM signature using the SIM private key (block 1140). Security unit 122 may compare the decryption result with the SIM contents retrieved from the SIM card by processor core 200. As mentioned above, the lock values to check may be software defined. Thus the result of the decryption may indicate whether communication apparatus 100 is unlocked or locked (block 1145). If the decryption result indicates communication apparatus 100 is unlocked, security unit 122 may provide a pass indication to processor core 200 (block 1155). In one embodiment, security unit 122 may provide the pass indication to processor core 200 immediately, without any further checks being performed.

However, if the decryption result indicates communication apparatus 100 is locked (block 1145), the decryption result may also include such parameters as the network ID, for example. Accordingly, security unit 122 may check whether the protected SIM contents retrieved from the SIM card match the values decrypted from the SIM signature (block 1150). If the lock values match the decryption result, security unit 122 may provide a pass indication to processor core 200 (block 1155), which may allow communication apparatus 100 to continue run-time operation.

However, if the lock values do not match the decryption result, security unit 122 may provide a fail indication to processor core 200 (block 1160). As described above, in response to a fail indication, processor core 200 may enter a non-exiting while loop, for example (block 1165). In one embodiment, the while loop may include instructions that may cause communication apparatus 100 to notify the network operator of the failure. However, in other embodiments, the while loop may include instructions that may cause communication apparatus 100 to become non-functional and/or may provide a message to a display indicating an invalid SIM card, for example.

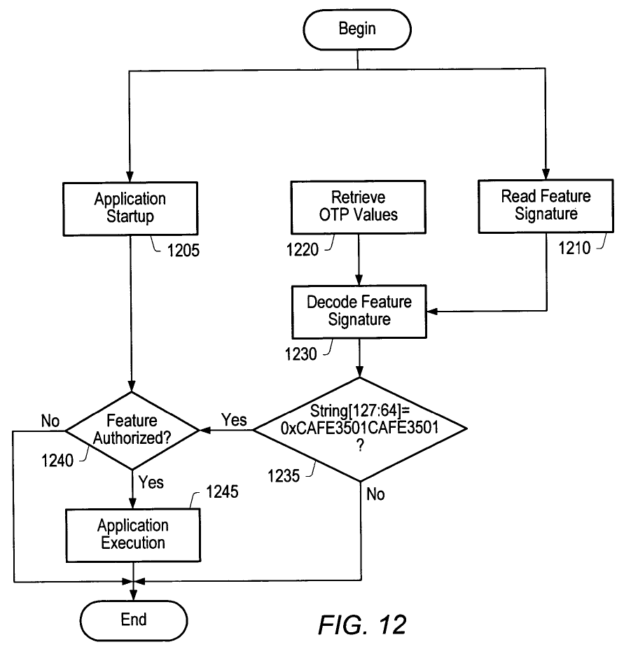

FIG. 12 is a flow diagram describing an exemplary run-time feature check operation of one embodiment of communication apparatus 100. As mentioned above, application software loaded on communication apparatus 100 may itself check whether it is authorized to run at run time. Referring collectively to FIG. 1 through FIG. 3 and FIG. 12, during initialization, such as maybe performed at power up or after a reset, security unit 122 may load various internal registers (block 1220) within register set 310 with values stored within OTP 255. Security unit 122 may also retrieve a feature set private key that was stored to OTP 255 during programming operations.

In addition, processor core 200 may read the feature set signature from flash memory 160 (block 1210), and provide the feature set signature to security unit 122. Once communication apparatus 100 has been booted into a run-time operational mode, application software stored within flash memory 160 may be selected for execution by a user, for example (block 1205). When the application starts, the application code executing on processor core 200 may perform a read request of the feature string from register set 310 of security unit 122. In response to the application code requesting the feature string, security unit 122 may decrypt the feature set signature using the feature private key. The decryption may result in the feature string. In one embodiment, security unit 122 checks the value of the decrypted feature string to determine if it is a valid string (block 1235). More particularly, the feature string may include a predetermined number of bits that correspond to a predetermined string check value. This may deter random writing of feature set signatures to the flash memory until an application runs. In some embodiments, if the security unit 122 determines the feature string is not valid based upon the check value, no applications may run. However if security unit 122 determines the feature string is valid, the feature string value may be written to register set 310.

The application determines whether it is authorized to run based upon the value of one or more bits in the feature string (block 1240). For example, a given application may correspond to one or more bits in the feature string. Thus the value of the one or more bits may be indicative of whether the application is authorized to run on communication apparatus 100. If the application determines it is not authorized to run, the application does not run, and in one implementation an error message may be displayed to the user, for example. If the application determines it is authorized to run, processor core 200 may execute the application code (block 1245).

To protect the integrity of the code executing on the processor core 200, the debugger cannot be able to intercept the operation of processor core 200, and change or replace instructions. Accordingly, the debugger may be locked out through programming of the one or more lock bits within OTP 255 during programming operations as described above in conjunction with the description of FIG. 8.

However, for system debug and diagnostics, it may be necessary to observe the operation of processor core 200, even after programming the one or more lock bits within OTP 255. Thus, if processor core 200 debug access via JTAG interface 260 has been locked as described above, it may be possible to restore JTAG access to the processor core 200 debug port through an appropriate signature write as described below.

Accordingly, FIG. 13 is a flow diagram describing an exemplary run-time operation including unlocking of a locked debug port of one embodiment of communication apparatus 100. Referring collectively to FIG. 1 through FIG. 3 and FIG 13, during initialization such as may be performed at power up or after a reset, for example, security unit 122 may initialize/load various internal registers within register set 310 with values stored within OTP 255 (block 1310). The values may include a unique serial number. Security unit 122 may also retrieve the flash private key that was stored to OTP 255 during programming operations.

It is noted that the code which re-enables the debug port may originate from any source such as flash memory 160 or the UART, if available. Similarly, the time at which the debug port becomes available may be based solely on when the request to restore the connection is made. Thus, the debug port re-connection may not be dependent on device pin settings at boot, a particular array of reads or writes to hidden registers, or any similar compromisable sequence.

As such, during operation, in response to processor core 200 executing the code that requests unlocking the debug port, processor core 200 may write a signature that was provided in the unlock code to register set 310 within security unit 122 (block 1305). In addition, in one embodiment, processor core 200 may write to a particular bit within one of the registers (e.g., flash check register) of register set 310 to initiate the unlock sequence. In response, security unit 122 may decrypt the signature using the flash private key (block 1320).

Security unit 122 may compare the decryption result with the serial number retrieved from OTP 255 (block 1325). If the result is not the same, the debug port is not enabled, and the JTAG interface 260 remains locked. However, if the serial number is the same as the decryption result, the debug port may be enabled and JTAG interface 260 may be unlocked (block 1330). In one embodiment, upon reset, the debug port may be disabled and JTAG interface 260 may be locked again.

Digital Rights Management is a very large area and protecting Rights may include several different implementations. For example, the first area where Rights Management may become involved is at the time digital content is obtained from a content provider. Just as there may be several methods to place content onto a mobile device, there may also be several ways that Rights Management may be implemented as it relates to the acquisition of content.

In one embodiment, the content provider may desire to deliver the content already encrypted using an encryption algorithm such as the GEA algorithm (described. above), thus protecting the work from the time it leaves the control of the content provider. Since content may, in the case of MP3 or video streams be quite large, it may or may not be delivered to the mobile device via the air interface. Instead, the Internet or a cable connection to a server at a store or kiosk, or the like may be used.

As described above, to access the encrypted content, the content must first be decrypted using a key (e.g., a content decryption key) that may be provided to E/D accelerator 225 by security unit 122, for example. However, the content decryption key may be supplied in an encrypted form by the content supplier. The content supplier may encrypt the content decryption key using a public key for Rights Management (i.e., rights public key) that is available to the mobile. As described below, there may be various ways to supply the public key for Rights Management of the mobile device to the content supplier. It is noted that in embodiments in which E/D accelerator 225 may implement a stream cipher, the content key used to encrypt the digital content may be the same key used to decrypt the digital content. In embodiments that use a different form of cipher, asymmetrical encryption may be used. As such, the digital content encryption key may be a public key and the digital content decryption key may be a private key, or vice versa.

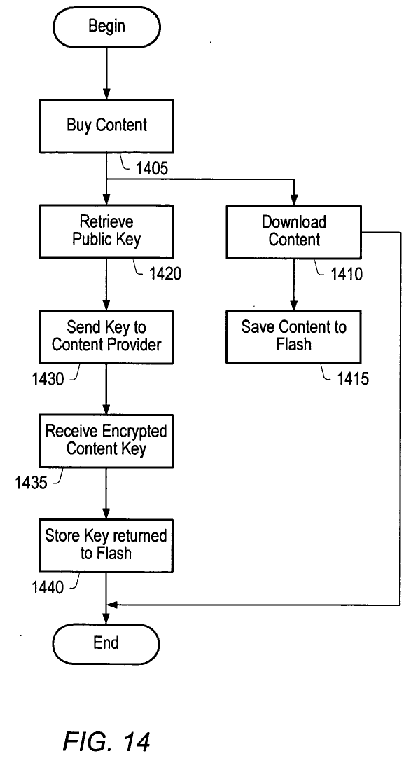

Accordingly, FIG. 14 through FIG. 17 are flow diagrams that describe exemplary operations in which digital content may be obtained and/or accessed by one embodiment of communications apparatus 100. Turning now to FIG. 14, a flow diagram describing an exemplary digital rights content purchase operation of one embodiment of the communication apparatus 100 is shown.

To obtain content, a user may buy the content from a content provider (block 1405). The content may be downloaded to communication apparatus 100 via any of a variety of methods (e.g., air, Internet, etc.) (block 1410). Since the content is in an encrypted state, processor core 200 may store the content to flash memory 160 (block 1415).

In addition, processor core 200 may retrieve the rights public key that was stored within OTP 255 during programming (block 1420) and may further send the rights public key to the content provider (block 1430). The content provider may return a content decryption key to communication device that is encrypted with the rights public key (block 1435). Processor core 200 may store the encrypted content decryption key within flash memory 160 (block 1440).

As will be described further below, to access the content stored in flash memory 160, security unit 122 may decrypt the encrypted content decryption key using a rights private key stored within OTP 255 and then provide the decrypted content decryption key to E/D accelerator 225 to decrypt the content.

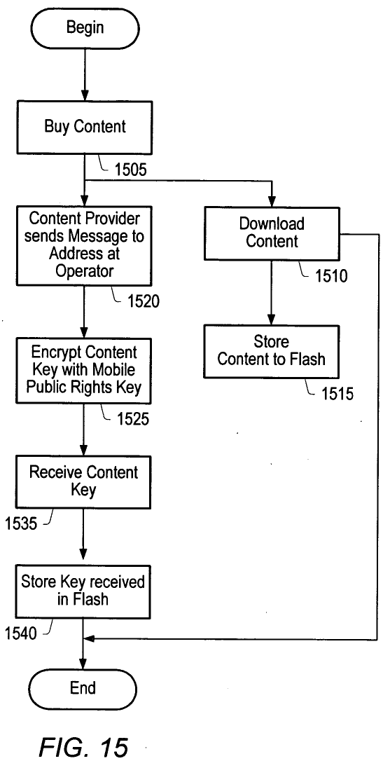

An alternative to having communication apparatus 100 supply the rights public key is to have the network operator maintain a key database, thereby limiting the sources of content keys, and aiding the content providers in verifying the end users. Accordingly, FIG. 15 is a flow diagram describing another exemplary digital rights content purchase operation of one embodiment of the communication apparatus 100.

Referring to FIG. 15, the content purchase (block 1505) and the download to communication apparatus 100 (blocks 1510 and 1515) may performed in the same manner as described above in the description of FIG. 14. However, when the content provider delivers the content decryption key, the network may supply a port or method where the rights public keys for a particular mobile device may be delivered through a special path (block 1520). This may be as simple as a secure SMS address, for example, or it may be more sophisticated. This decision may be up to the network operators and the content providers to determine. The content provider, or the network operator may encrypt the content decryption key for the mobile device using the Digital Rights Public Key (block 1525) based on agreements between operators and content providers. Processor core 200 may receive the encrypted content decryption key (block 1535) and may store the encrypted decryption content key within flash memory unit 160. As described below, the content decryption key may be used when accessing the purchased content.

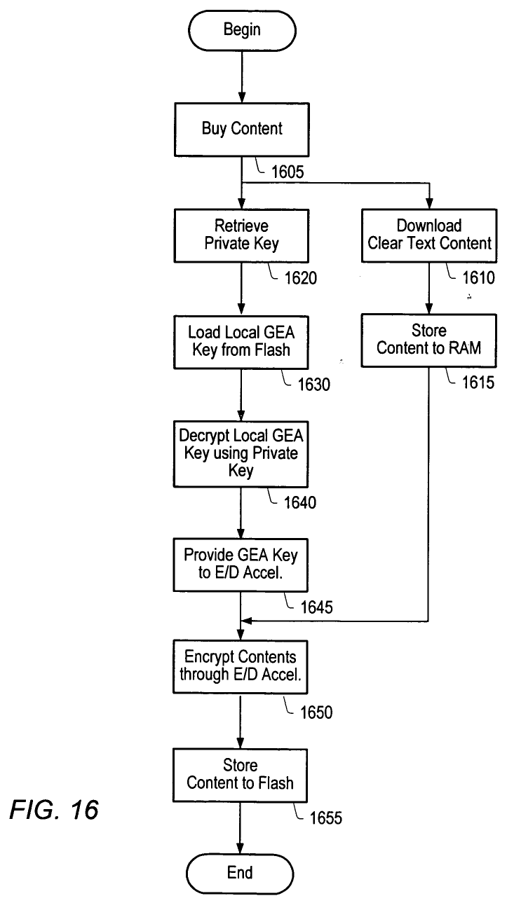

FIG. 16 is a flow diagram describing an additional exemplary digital rights content purchase operation of one embodiment of the communication apparatus 100. More particularly, in lieu of sending a public rights key to content providers, or making use of special addresses on the network to deliver purchased keys, and still maintaining a level of security that makes it difficult to move content from one mobile device to another, the content provider may send content in clear text. However, in such a case, the content provider may require that the content be stored in an encrypted form on the mobile device, particularly when stored in non-volatile memory. In this case, the download path would tend to be the air interface, as having the content on a computer, or other non-mobile location effectively defeats the security imposed by the mobile device. Accordingly, the content may be locally encrypted using a GEA encryption key that is programmed into the mobile device by the manufacturer using the rights public key. In addition, software responsible for the download procedures may be programmed to use the GEA key when storing the received content.

Turning to FIG. 16, to obtain content, a user may buy the content in a clear text format (i.e., unencrypted) from a content provider (block 1605). The content may be downloaded to communication apparatus 100 via the air interface, for example (block 1610). Since the content is not encrypted, processor core 200 may store the content into RAM 150 (block 1615).

In addition, security unit 122 may retrieve the rights private encryption key that was stored within OTP 255 (block 1620). Processor core 200 may retrieve the encrypted GEA key from flash memory 160 (block 1630). Security unit 122 may decrypt the GEA key using the rights private key (block 1640) and provide the decrypted GEA key to E/D accelerator 225 (block 1645).

Processor core 200 may initialize DMA engine 205 to transfer content from RAM 150 to E/D accelerator 225. Accordingly, in one embodiment, E/D accelerator 225 may receive the content stored in RAM 150 via DMA engine 205. E/D accelerator 225 may encrypt the content using the GEA key (block 1650) and then store the encrypted contents to flash 160 via DMA engine 205 (block 1655).

As described above, when digital content is stored within a non-volatile memory such as flash memory 160 of communication apparatus 100, it is in an encrypted state. Thus, to use encrypted content stored within flash memory 160, a decryption operation to restore the content to a clear text state may be used prior to software accessing and using the stored content.

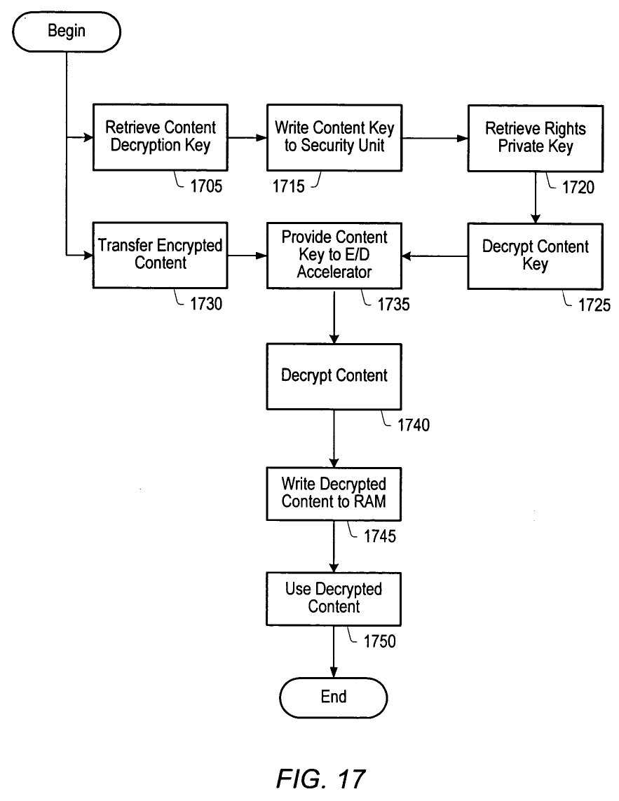

As such, FIG. 17 is a flow diagram describing an exemplary digital rights content access operation of one embodiment of the communication apparatus of FIG. 1. During operation, software executing on processor core 200 may request to use content stored within flash memory 160. In response, processor core 200 may retrieve the encrypted content decryption key from flash memory 160 (block 1705) and write the content decryption key to register set 310 of security unit 122 (block 1715). Security unit 122 may retrieve the rights private key from OTP 255 (block 1720) and then decrypt the content decryption key using the rights private key (block 1725).

Security unit 122 may provide the decrypted content decryption key to E/D accelerator 225 (block 1735). Processor core 200 may initialize DMA engine 205 to begin transferring encrypted digital content from flash 160 to E/D accelerator 225 (block 1730). E/D accelerator 225 may decrypt the content (block 1740) and write the decrypted content to RAM 150 (block 1745) via DMA engine 205. Software executing on processor core 200 may access and use the clear text content stored within RAM 150 (block 1750). It is noted that in some embodiments, IRAM 210 may also be used in lieu of and/or in combination with RAM 150, when accessing the clear text content.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless communication apparatus comprising:
a processor core configured to receive digital content encrypted with a first encryption key and to store the encrypted digital content within a memory unit of the wireless communication apparatus;
wherein the processor core is further configured to receive a second encryption key encrypted with a third encryption key and to store the encrypted second encryption key within the memory unit;
a programmable memory unit configured to store a fourth encryption key; and
a security unit coupled to the processor core and to the programmable memory unit, wherein the security unit is configured to decrypt the second encryption key using the fourth encryption key;
an encryption/decryption unit configured to decrypt the digital content into clear text digital content using the second encryption key.

2. The wireless communication apparatus as recited in claim 1, wherein the security unit is configured to provide the second encryption key to the encryption/decryption unit.

3. The wireless communication apparatus as recited in claim 1, further comprising a second memory unit coupled to the processor core and configured to store the clear text digital content.

4. The wireless communication apparatus as recited in claim 3, wherein the second memory unit comprises a volatile random access memory (RAM) memory unit..

5. The wireless communication apparatus as recited in claim 3, further comprising a direct memory access (DMA) unit coupled to transfer encrypted digital content from the memory unit to the encryption/decryption unit, and wherein the DMA unit is further configured to transfer the clear text digital content from the encryption/decryption unit to the second memory unit.

6. The wireless communication apparatus as recited in claim 1, wherein the memory unit comprises a non-volatile flash memory.

7. The wireless communication apparatus as recited in claim 1, wherein the first encryption key comprises a public digital content encryption key, and wherein the second encryption key comprises a private digital content encryption key.

8. The wireless communication apparatus as recited in claim 7, wherein the public and private digital content encryption keys correspond to an asymmetric encryption key pair.

9. The wireless communication apparatus as recited in claim 1, wherein the first encryption key comprises a private digital content encryption key, and wherein the second encryption key comprises a public digital content encryption key.

10. The wireless communication apparatus as recited in claim 1, wherein the third encryption key comprises a public digital rights encryption key, and wherein the fourth encryption key comprises a private digital rights encryption key.

11. The wireless communication apparatus as recited in claim 10, wherein the public and private digital rights encryption keys correspond to an asymmetric encryption key pair.

12. The wireless communication apparatus as recited in claim 1, wherein the third encryption key comprises a private digital rights encryption key, and wherein the fourth encryption key comprises a public digital rights encryption key.

13. The wireless communication apparatus as recited in claim 1, wherein the first encryption key and the second encryption key comprise the same private digital content encryption key.

14. The wireless communication apparatus as recited in claim 13, wherein the encryption/decryption unit comprises an encryption/decryption hardware accelerator that implements an A5 algorithm.

15. The wireless communication apparatus as recited in claim 1, wherein the security unit includes a decryption engine comprising an RSA decryption algorithm implemented using hardware.

16. The wireless communication apparatus as recited in claim 5, wherein the processor core is further configured to receive clear text digital content and to store the clear text digital content within the second memory unit.

17. The wireless communication apparatus as recited in claim 16, wherein the encryption/decryption unit is further configured to encrypt the clear text digital content using the second encryption key.

18. The wireless communication apparatus as recited in claim 17, wherein the DMA unit is configured to transfer the clear text digital content from the second memory unit to the encryption/decryption unit, and wherein the DMA unit is further configured to transfer the encrypted digital content from the encryption/decryption unit to the memory unit.

19. The wireless communication apparatus as recited in claim 18, wherein the processor core is further configured to access the clear text digital content within the second memory unit.

20. The wireless communication apparatus as recited in claim 1, wherein the programmable memory unit comprises a one-time programmable (OTP) memory.

21. A method of securing digital content within a wireless communication apparatus, the method comprising:
receiving the digital content encrypted with a first encryption key;
storing the encrypted digital content within a memory unit of the wireless communication apparatus;
receiving a second encryption key that is encrypted with a third encryption key;
storing the encrypted second encryption key within the memory unit of the wireless communication apparatus; and
storing a fourth encryption key within a programmable memory unit of the wireless communication apparatus.

22. The method as recited in claim 21, further comprising sending the third encryption key to a provider of the digital content.

23. The method as recited in claim 22, further comprising the provider encrypting the second encryption key with the third encryption key.

24. The method as recited in claim 21, further comprising a provider of the digital content retrieving the third encryption key from a network operator.

25. The method as recited in claim 24, further comprising the provider encrypting the second encryption key with the third encryption key.

26. The method as recited in claim 21, further comprising decrypting the second encryption key using the fourth encryption key.

27. The method as recited in claim 26, further comprising decrypting the digital content into clear text digital content using the second encryption key and storing the clear text digital content within a second memory unit of the wireless communication apparatus.

28. The method as recited in claim 21, wherein the first encryption key comprises a private digital content key and the second encryption key comprises a public digital content key.

29. The method as recited in claim 21, wherein the third encryption key comprises a public digital rights management key and the fourth encryption key comprises a private digital rights management key.

30. The method as recited in claim 21, wherein the first encryption key and the second encryption key comprise the same private digital content key.

31. The method as recited in claim 21, wherein the memory unit comprises a non-volatile flash memory.

32. The method as recited in claim 21, wherein the programmable memory unit comprises a one-time programmable memory unit.

33. A method of securing digital content within a wireless communication apparatus, the method comprising:
receiving clear text digital content;
storing the clear text digital content within a first memory unit of the wireless communication apparatus;
receiving a first encryption key that is encrypted with a second encryption key;
retrieving a third encryption key from a programmable memory unit within the wireless communication apparatus;
decrypting the encrypted first encryption key using the third encryption key;
encrypting the clear text digital content using the decrypted first encryption key; and
storing the encrypted digital content within a second memory unit of the wireless communication apparatus.

34. The method as recited in claim 33, wherein the first encryption key comprises a private digital content key.

35. The method as recited in claim 33, wherein the second encryption key comprises a public digital rights management key.

36. The method as recited in claim 33, wherein the third encryption key comprises a private digital rights management key.

37. The method as recited in claim 33, wherein the first memory unit comprises a volatile random access memory (RAM).

38. The method as recited in claim 33, wherein the second memory unit comprises a non-volatile flash memory.

39. The method as recited in claim 33, wherein the programmable memory unit comprises a one-time programmable memory unit.

40. The method as recited in claim 33, further comprising using direct memory access (DMA) transfers for retrieving the clear text digital content from the first memory unit and storing the encrypted digital content within the second memory unit.

41. A method of securing digital content within a wireless communication apparatus, the method comprising:
retrieving a first encryption key from a first memory unit within the wireless communication apparatus, wherein the first encryption key is in an encrypted state;
retrieving a second encryption key from a programmable memory unit within the wireless communication apparatus;
decrypting the first encryption key using the second encryption key;
retrieving encrypted digital content from the first memory unit; and
decrypting the encrypted digital content into clear text digital content using the decrypted first encryption key.

42. The method as recited in claim 41, further comprising storing the clear text digital content within a second memory unit within the wireless communication apparatus.

43. The method as recited in claim 42, further comprising accessing the clear text digital content stored within the second memory unit.

44. The method as recited in claim 43, wherein the second memory unit comprises a volatile random access memory (RAM).

45. The method as recited in claim 41, wherein the first encryption key comprises a private digital content key.

46. The method as recited in claim 41, wherein the second encryption key comprises a private digital rights management key.

47. The method as recited in claim 41, wherein the first memory unit comprises a non-volatile flash memory.

48. The method as recited in claim 41, wherein the programmable memory unit comprises a one-time programmable memory unit.

49. The method as recited in claim 41, further comprising a security unit within the wireless communication apparatus providing the decrypted first encryption key to an encryption/decryption accelerator unit.

50. The method as recited in claim 41, further comprising retrieving the encrypted digital content from the first memory unit and storing the clear text digital content within the second memory unit using direct memory access (DMA) transfers.
